(19) United States
(12) Patent Application Publication
(10) Pub. No.: US 2006/0202660 A1
(43) Pub. Date: Sep. 14, 2006

(54) Wireless mouse charger

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/073,662

(22) Filed: Mar. 8, 2005

(51) Int. Cl. H02J 7/00

(52) U.S. Cl. 320/115

(57) ABSTRACT

A wireless mouse charger has a housing, a circuit unit, a signal connection interface, and an expansion transmission interface. The signal connection interface electrically connects to the circuit unit for connecting to a mainframe. The expansion transmission interface electrically connects to the circuit unit for connecting to a peripheral device. Connecting the peripheral device and the expansion transmission interface is very easy, and after the connection, the peripheral device is viewed and operated by the user simply.

### BACKGROUND OF THE INVENTION

1. Field of the Invention

The present invention relates to a wireless mouse charger, and more particularly, to a wireless mouse charger that has the function of connecting with a peripheral device.

2. Description of Related Art

A mainframe has a number of connectors for connecting various peripheral devices, such as an external disk driver, a personal digital assistant, a card reader, a recorder, a digital camera, a portable disk driver, and so forth. Generally, the connectors are arranged on the back of the mainframe. It is inconvenient to connect peripheral devices to the back of the mainframe via connection cords. Different peripheral devices have different keys, indication lamps, and display panels according to their functions. It is more inconvenient to directly connect peripheral devices to the back of the mainframe without using connection cords, so that after connection, the user is unable to view and operate the peripheral devices.

Additionally, a mouse is a basic peripheral device for data input, and a display is a basic peripheral device for data output. It is very easy to use a mouse to move a curser on a display and to click and select an option on the display.

A conventional mouse is a wired mouse having a mouse body and a transmission cord. The transmission cord has an end connecting to the mouse body, the other end connecting to a mainframe. When moving the wired mouse on a table, the transmission cord often gets in the user's way. Hence, a wireless mouse without a transmission cord and a receiving device for receiving wireless signals from the wireless mouse were developed. The receiving device is placed on a table and has a transmission cord connected to the mainframe. When the wireless mouse is operated on the table, the receiving device receives wireless signals from the wireless mouse, and the wireless signals are transmitted to the mainframe via the transmission cord.

Furthermore, since a wireless mouse does not have a transmission cord like a wired mouse, a battery is placed in the wireless mouse for supplying power for transmitting wireless signals. In order to recharge the power of the battery placed in the wireless mouse, a charging function is combined with the receiving device to form a wireless mouse charger.

Referring to FIG. 1, a conventional wireless mouse charger includes a housing 6 and a contact set 7. The housing 6 has a cavity 61 for receiving a rechargeable wireless mouse 91. The contact set 7 is disposed in the housing 6. The contact set 7 includes an anode contact 71 and a cathode contact 72 protruding into the cavity 61. An inside rechargeable battery is placed in the rechargeable wireless mouse 91 for supplying power for transmitting wireless signals. The rechargeable wireless mouse 91 has an anode pad and a cathode pad on a surface thereof. When the rechargeable wireless mouse 91 is placed in the cavity 61 of the housing 6, the anode pad and the cathode pad respectively and electrically contact the anode contact 71 and the cathode contact 72, so that the rechargeable battery inside the rechargeable wireless mouse 91 is charged via the housing 6.

The functions of the conventional wireless mouse charger are only limited to the needs of the rechargeable wireless mouse 91. In other words, the functions are only receiving the wireless signals from the rechargeable wireless mouse 91 and the charging function. There are no additional functions. The charging function is only for the inside rechargeable battery placed in the rechargeable wireless mouse 91. When the rechargeable wireless mouse 91 is in use, the inside rechargeable battery cannot be charged simultaneously. Once the power of the inside rechargeable battery is exhausted, the use of the rechargeable wireless mouse 91 is interrupted, causing great inconvenience to the user. The user has to spend more money to purchase spare batteries, yet the batteries are easily lost due to their small size.

Accordingly, as discussed above, the conventional wireless mouse charger still has some drawbacks that could be improved upon. The present invention aims to resolve the drawbacks of the prior art.

### SUMMARY OF THE INVENTION

The primary objective of the invention is therefore to specify a wireless mouse charger that has a function of connecting a peripheral device, so as to increase the practicability thereof.

Another objective of the invention is therefore to specify a wireless mouse charger that simultaneously charges the rechargeable wireless mouse and the spare rechargeable battery, so as to ensure that the use of the rechargeable wireless mouse is not interrupted due to lack of power.

According to the invention, the objectives are achieved via a wireless mouse charger comprising a housing, a circuit unit, a signal connection interface, and an expansion transmission interface. The circuit unit is disposed in the housing. The signal connection interface is disposed on the housing and electrically connects to the circuit unit for connecting to a mainframe. The expansion transmission interface is disposed on the housing and electrically connects to the circuit unit for connecting to a peripheral device.

The connection between the peripheral device and the expansion transmission interface is very easy, and after the connection has been made, the peripheral device can be simply viewed and operated by the user. Therefore, the practicability of the wireless mouse charger of the present invention is increased.

In a preferable embodiments the housing has a mouse cavity for receiving a rechargeable wireless mouse therein, the wireless mouse charger includes a first contact set disposed in the housing, the first contact set includes a first anode contact and a first cathode contact, and the first anode contact and the first cathode contact protrude into the mouse cavity.

In another preferred embodiment, the housing has a first inner sidewall and a second inner sidewall, and the mouse cavity is formed between the first inner sidewall and the second inner sidewall.

In another preferred embodiment, the housing has a battery cavity for receiving a rechargeable battery therein, the wireless mouse charger includes a second contact set disposed in the housing, the second contact set includes a second anode contact and a second cathode contact, and the second anode contact and the second cathode contact protrude into the battery cavity.

The mouse cavity and the battery cavity of the housing are for receiving a rechargeable wireless mouse therein and a rechargeable battery therein, respectively, such that the wireless mouse charger of the present invention simultaneously charges an inside rechargeable battery placed in the rechargeable wireless mouse and a spare rechargeable battery placed in the battery cavity. Therefore, when the power of the inside rechargeable battery runs out, the spare rechargeable battery replaces the inside rechargeable battery, so as to ensure that the use of the rechargeable wireless mouse is not interrupted due lack of power.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily be appreciated as the same becomes better understood by reference to the following detailed description, when taken in conjunction with the accompanying drawings, wherein:

FIG. 1 is a schematic perspective view of a wireless mouse charger of the prior art and a rechargeable wireless mouse before being placed on the wireless mouse charger;

FIG. 2 is a front view of a wireless mouse charger of the present invention;

FIG. 3 is a perspective view of a wireless mouse charger of the present invention;

FIG. 4 is a perspective view of a wireless mouse charger of the present invention, a rechargeable wireless mouse before being placed on the wireless mouse charger, and peripheral devices before being connected to the wireless mouse charger;

FIG. 5 is a schematic block diagram when a wireless mouse charger of the present invention is applied;

FIG. 6 is a perspective view of a wireless mouse charger of the present invention, a rechargeable battery before being placed in the wireless mouse charger, and peripheral devices before being connected to the wireless mouse charger;

FIG. 7 is a perspective view of a wireless mouse charger of the present invention, a rechargeable battery placed in the wireless mouse charger, and peripheral devices before being connected to the wireless mouse charger;

FIG. 8 is another schematic block diagram when a wireless mouse charger of the present invention is applied;

FIG. 9 is a perspective view of a wireless mouse charger of the present invention, a rechargeable battery placed in the wireless mouse charger, a rechargeable wireless mouse before being placed on the wireless mouse charger, and peripheral devices before being connected to the wireless mouse charger; and

FIG. 10 is still another schematic block diagram when a wireless mouse charger of the present invention is applied.

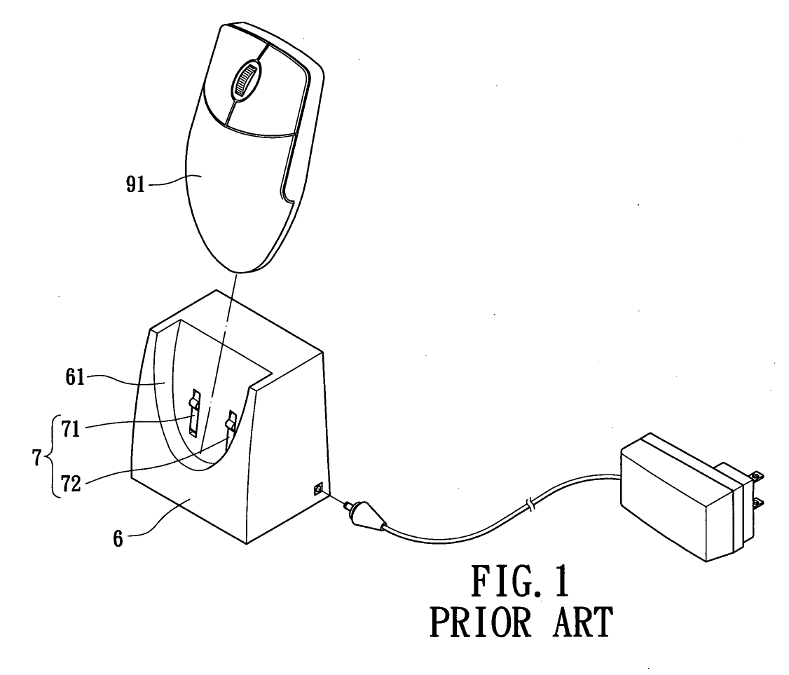

### DETAILED DESCRIPTION OF PREFERRED EMBODIMENTS

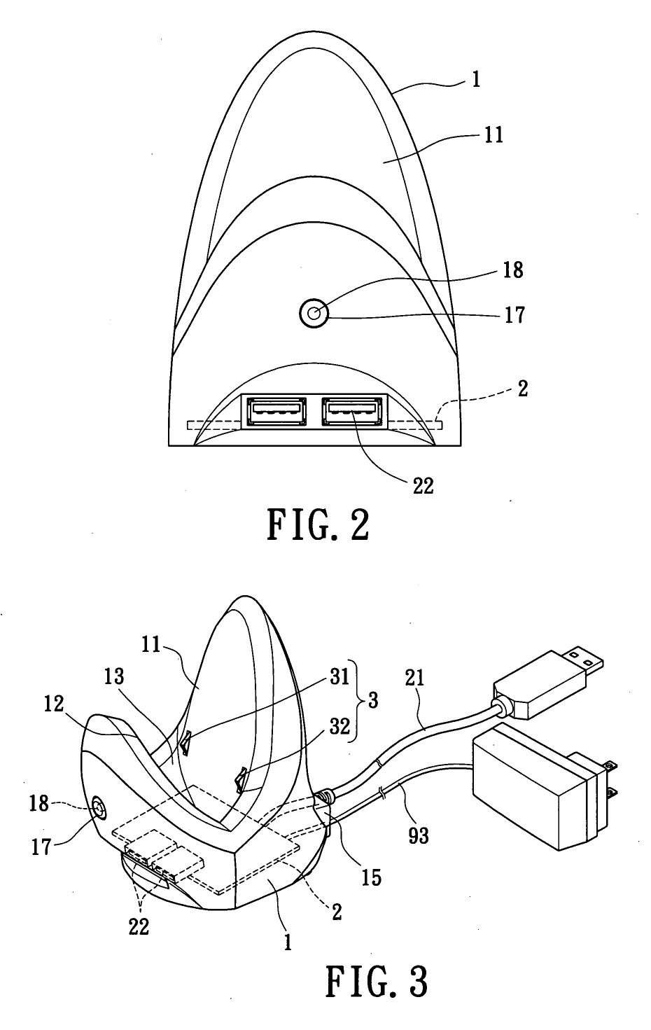

Referring to FIGS. 2-5, the present invention provides a wireless mouse charger. The wireless mouse charger comprises a housing 1, a circuit unit 2, a signal connection interface 21, an expansion transmission interface 22, and a first contact set 3.

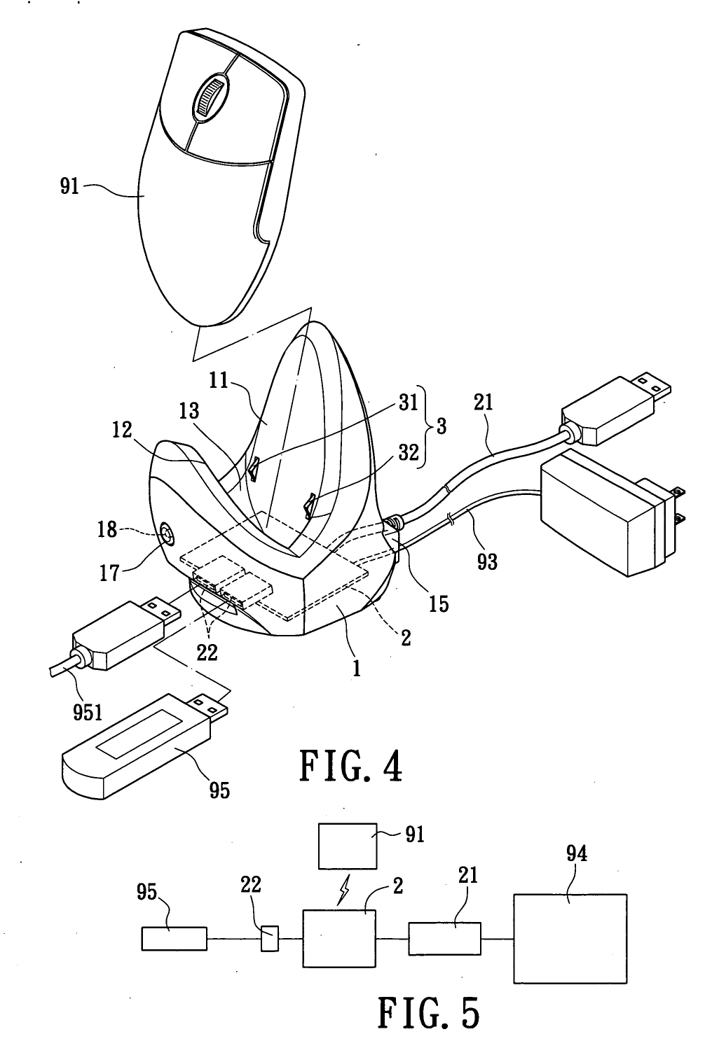

The housing 1 has a first inner sidewall 11, a second inner sidewall 12, and a mouse cavity 13. The mouse cavity 13 is formed between the first inner sidewall 11 and the second inner sidewall 12. As shown in FIG. 4, the mouse cavity 13 is for receiving a rechargeable wireless mouse 91 therein.

The circuit unit 2 is disposed in the housing 1. The circuit unit 2 has a charge and over-charge protection circuit for processing the charging process of the rechargeable wireless mouse 91. The circuit unit 2 has a signal receiving circuit for processing the wireless signals generated by the rechargeable wireless mouse 91 when it is in use.

The housing 1 further has a signal connection key 17 electrically connecting the signal receiving circuit of the circuit unit 2 for setting the wireless connection between the wireless mouse charger of the present invention and the rechargeable wireless mouse 91, and has a connecting indication lamp 18 electrically connecting the signal receiving circuit of the circuit unit 2 for displaying the signal connecting status of the rechargeable wireless mouse 91.

The signal connection interface 21 is disposed on the housing 1 and electrically connects to the circuit unit 2. In this embodiment, the signal connection interface 21 is a transmission cord, and the transmission cord has a connector of universal serial bus (USB) type. As shown in FIG. 5, the signal connection interface 21 has an end electrically connecting to the signal receiving circuit of the circuit unit 2, and has another end for electrically connecting to a mainframe 94 such as a desktop or a laptop computer.

The expansion transmission interface 22 is disposed on the housing 1 and electrically connects to the circuit unit 2. In this embodiment, the expansion transmission interface 22 is a connector of universal serial bus (USB) type. The expansion transmission interface 22 is for connecting to a peripheral device 95 (or its connection cord 951) such as an external disk driver, a personal digital assistant, a card reader, a recorder, a digital camera, or a portable disk driver.

The first contact set 3 is disposed in the housing 1. The first contact set 3 includes a first anode contact 31 and a first cathode contact 32 electrically connecting to the charge and over-charge protection circuit of the circuit unit 2. The first anode contact 31 and the first cathode contact 32 protrude into the mouse cavity 13 for electrically contacting the rechargeable wireless mouse 91.

The housing 1 has a power connector 15 electrically connecting to the charge and over-charge protection circuit of the circuit unit 2 for connecting to a power cord 93. The inside rechargeable battery placed in the rechargeable wireless mouse 91 is charged through the power cord 93.

The power connector 15 of the housing 1 and the power cord 93 connected thereon may be integrated with the signal connection interface 21 and the power supply of the mainframe 94, and the signal connection interface 21 is electrically connected to the charge and over-charge protection circuit of the circuit unit 2.

When the wireless mouse charger of the present invention is in use, it is placed on a working face (such as a table), the signal connection interface 21 connects to the mainframe 94, and the expansion transmission interface 22 connects to the peripheral device 95. The mainframe 94 and the peripheral device 95 transmit signals to each other via the signal connection interface 21, the circuit unit 2, and the expansion transmission interface 22 of the wireless mouse charger of the present invention. Since the wireless mouse charger is close to the user, connecting the peripheral device 95 and the expansion transmission interface 22 is very easy, and after the connection, the peripheral device 95 is viewed and operated by the user simply. Meanwhile, when the rechargeable wireless mouse 91 is in use, or when the rechargeable wireless mouse 91 is placed in the mouse cavity 13 for being charged, the mainframe 94 and the peripheral device 95 still transmit signals to each other.

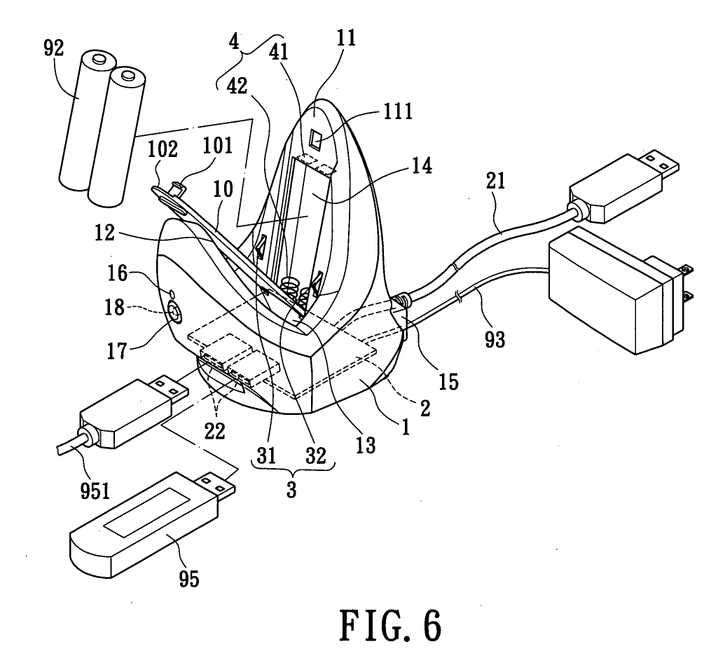

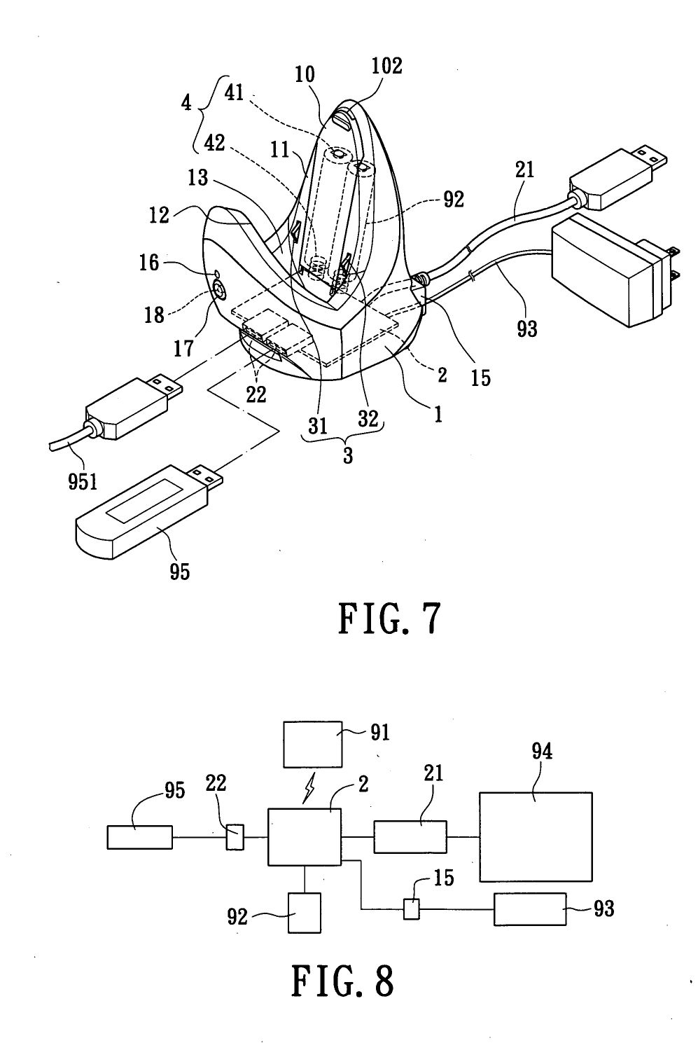

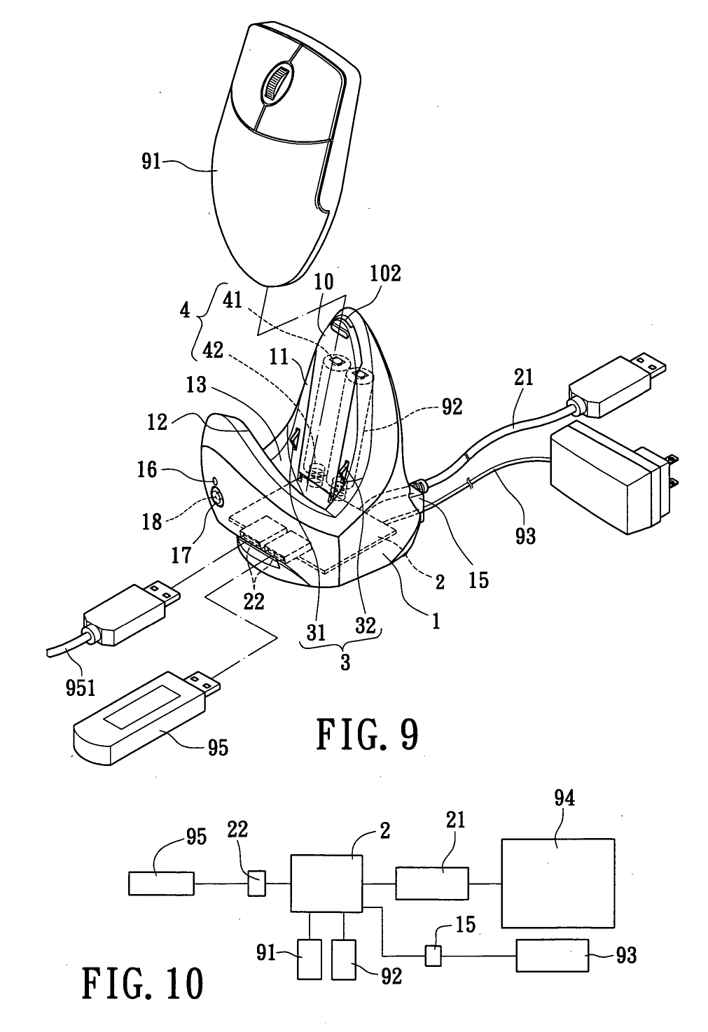

Referring to FIGS. 6-10, the wireless mouse charger of the present invention further includes a second contact set 4, and the housing 1 further has a battery cavity 14. The battery cavity 14 is formed in the first inner sidewall 11 of the housing 1. As shown in FIG. 6, the battery cavity 14 is for receiving a rechargeable battery 92 therein.

The second contact set 4 is disposed in the housing 1. The second contact set 4 includes a second anode contact 41 and a second cathode contact 42 electrically connecting to the charge and over-charge protection circuit of the circuit unit 2. The second anode contact 41 and the second cathode contact 42 protrude into the battery cavity 14 for electrically contacting to the rechargeable battery 92.

The spare rechargeable battery 92 placed in the battery cavity 14 is charged through a power cord 93. The charge and over-charge protection circuit of the circuit unit 2 also processes the charging process of the rechargeable battery 92. The housing 1 has a charging indication lamp 16 electrically connecting to the charge and over-charge protection circuit of the circuit unit 2 for displaying the charging status of the spare rechargeable battery 92 placed in the battery cavity 14.

In this embodiment, the housing 1 further includes a lid 10. As shown in FIG. 6, the lid 10 has a hook arm 101, and the first inner sidewall 11 of the housing 1 has a hook hole 111. The lid 10 has an edge pivotally connecting to the first inner sidewall 11. The hook arm 101 detachably hooks into the hook hole 111, so that the lid 10 has another edge detachably hooking into the first inner sidewall 11, and so that the lid 10 liftably covers the battery cavity 14, so as to prevent outside dust or objects from entering the battery cavity 14. In addition, the lid 10 has a cutout 102 adjacent to the hook arm 101 for easily lifting the lid 10.

When the wireless mouse charger of the present invention is in use, the signal connection interface 21 connects to the mainframe 94 and the power cord 93 connects to an external power source. The spare rechargeable battery 92 is placed in the battery cavity 14 and has an anode pad (not labeled) and a cathode pad (not labeled) respectively and electrically contacting the second anode contact 41 and the second cathode contact 42 to charge the battery. When the rechargeable wireless mouse 91 is not in use, it is placed in the mouse cavity 13. An inside rechargeable battery (not shown) placed in the rechargeable wireless mouse 91 electrically connects to the first anode contact 31 and the first cathode contact 32 through an anode pad (not shown) and a cathode pad (not shown) on a surface of the rechargeable wireless mouse 91 respectively to charge the battery. Therefore, the inside rechargeable battery placed in the rechargeable wireless mouse 91 and the spare rechargeable battery 92 placed in the battery cavity 14 can be simultaneously charged. When the rechargeable wireless mouse 91 is in use, the inside rechargeable battery placed in the rechargeable wireless mouse 91 supplies power for transmitting wireless signals. When the rechargeable wireless mouse 91 is moved or its keys or roller are operated, the connecting indication lamp 18 of the housing 1 shows the status of the wireless signals generated by the rechargeable wireless mouse 91. When the power of the inside rechargeable battery placed in the rechargeable wireless mouse 91 runs out, the spare rechargeable battery 92 replaces the inside rechargeable battery, so as to ensure that the use of the rechargeable wireless mouse 91 is not interrupted due to lack of power. Furthermore, when the rechargeable wireless mouse 91 is in use or placed in the mouse cavity 13 for recharging, or when the spare rechargeable battery 92 is placed in the battery cavity 14 for recharging, the mainframe 94 and the peripheral device 95 can still transmit signals to each other.

As indicated above, the wireless mouse charger of the present invention has the following advantages:

(1) Connecting the peripheral device and the expansion transmission interface is very easy, and after connection, the peripheral device is viewed and operated by the user simply. Therefore, the practicability of the wireless mouse charger of the present invention is better than that of the prior art.

(2) The mouse cavity and the battery cavity of the housing are for receiving a rechargeable wireless mouse therein and a rechargeable battery therein, respectively, such that the wireless mouse charger of the present invention can simultaneously charge the inside rechargeable battery placed in the rechargeable wireless mouse and the spare rechargeable battery placed in the battery cavity. Therefore, when the power of the inside rechargeable battery runs out, the spare rechargeable battery replaces the inside rechargeable battery, so as to ensure that the use of the rechargeable wireless mouse is not interrupted due to a lack of power.

(3) The wireless mouse charger of the present invention has a function of connecting to a peripheral device, a charging function, and a signal receiving function, so that it is more practical.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A wireless mouse charger comprising:
a housing;
a circuit unit disposed in the housing;
a signal connection interface disposed on the housing and electrically connecting to the circuit unit for connecting to a mainframe; and
an expansion transmission interface disposed on the housing and electrically connecting to the circuit unit for connecting to a peripheral device.

2. The wireless mouse charger as claimed in claim 1, wherein the signal connection interface is a transmission cord.

3. The wireless mouse charger as claimed in claim 2, wherein the transmission cord has a connector of universal serial bus (USB) type.

4. The wireless mouse charger as claimed in claim 1, wherein the expansion transmission interface is a connector of universal serial bus (USB) type.

5. The wireless mouse charger as claimed in claim 1, wherein the housing has a mouse cavity for receiving a rechargeable wireless mouse therein, the wireless mouse charger includes a first contact set disposed in the housing, the first contact set includes a first anode contact and a first cathode contact, and the first anode contact and the first cathode contact protrude into the mouse cavity.

6. The wireless mouse charger as claimed in claim 5, wherein the housing has a first inner sidewall and a second inner sidewall, and the mouse cavity is formed between the first inner sidewall and the second inner sidewall.

7. The wireless mouse charger as claimed in claim 6, wherein the housing has a battery cavity for receiving a rechargeable battery therein, the wireless mouse charger includes a second contact set disposed in the housing, the second contact set includes a second anode contact and a second cathode contact, and the second anode contact and the second cathode contact protrude into the battery cavity.

8. The wireless mouse charger as claimed in claim 7, wherein the battery cavity is formed in the first inner sidewall.

9. The wireless mouse charger as claimed in claim 8, wherein the housing includes a lid, the lid has an edge pivotally connecting to the first inner sidewall, the lid has another edge detachably hooking in the first inner sidewall, and the lid liftably covers on the battery cavity.

10. The wireless mouse charger as claimed in claim 9, wherein the lid has a hook arm, the first inner sidewall of the housing has a hook hole, and the hook arm detachably hooks into the hook hole.

11. The wireless mouse charger as claimed in claim 9, wherein the lid has a cutout.

12. The wireless mouse charger as claimed in claim 7, wherein the housing has a charging indication lamp for displaying the charging status of the rechargeable battery placed in the battery cavity.

13. The wireless mouse charger as claimed in claim 7, wherein the housing has a power connector for connecting to a power cord.

14. The wireless mouse charger as claimed in claim 5, wherein the housing has a signal connection key for setting the wireless connection between the wireless mouse charger and the rechargeable wireless mouse.

15. The wireless mouse charger as claimed in claim 5, wherein the housing has a connecting indication lamp for displaying the signal connecting status of the rechargeable wireless mouse.
